(19) United States
(12) Patent Application Publication
(10) Pub. No.: US 2023/0297831 A1
(43) Pub. Date: Sep. 21, 2023

(54) SYSTEMS AND METHODS FOR IMPROVING TRAINING OF MACHINE LEARNING SYSTEMS

(71) Applicant: Saad Saadi, Mahwah, NJ (US)

(72) Inventor: Saad Saadi, Mahwah, NJ (US)

(21) Appl. No.: 18/019,115

(22) PCT Filed: Aug. 17, 2021
(86) PCT No.: PCT/US2021/046361

§ 371 Date: Feb. 1, 2023

Related U.S. Application Data
(60) Provisional application No. 63/066,487, filed on Aug. 17, 2020.

(51) Int. Cl. G06N 3/08

(52) U.S. Cl. CPC G06N 3/08

(57) ABSTRACT

The present disclosure relates to systems and methods for improved training of machine learning systems. The system includes a local software application executing on a mobile terminal (e.g., a smart phone or a tablet) of a user. The system generates a user interface that allows for rapid retraining of a machine learning model of the system utilizing feedback data provided by the user and/or crowdsourced training feedback data. The crowdsourced training feedback data can include live, real-world data captured by a sensor (e.g., a camera) of a mobile terminal.

### PRIORITY

This application claims priority to U.S. Provisional Patent Application Ser. No. 63/066,487, filed Aug. 17, 2020, entitled “SYSTEMS AND METHODS FOR IMPROVED TRAINING OF MACHINE LEARNING SYSTEMS”, the contents of which are hereby incorporated by reference in its entirety.

### BACKGROUND

### Field

The present disclosure relates generally to the field of machine learning technology. More specifically, the present disclosure relates to systems and methods for improved training of machine learning systems.

### Description of the Related Art

Machine learning algorithms, such as convolutional neural networks (CNNs), trained on large datasets provide state-of-the-art results on various processing tasks, for example, image processing tasks including object and text classification. However, training CNNs on large datasets is challenging because training requires considerable time to manually label training data, computationally intensive server-side processing, and significant bilateral communications with the server. Identifying and labeling data via strategies like active learning can aid with mitigating such challenges.

Therefore, there is a need for systems and methods which can improve the training of machine learning systems via a customized and locally-executing training application that can also provide for crowdsourced training feedback such as labeled training data from a multitude of users. These and other needs are addressed by the systems and methods of the present disclosure.

### SUMMARY

The present disclosure relates to systems and methods for improved training of machine learning systems. The system includes a local software application executing on a mobile terminal (e.g., a smart phone or a tablet) of a user. The system generates a user interface that allows for retraining of a machine learning model of the system utilizing feedback data provided by the user and/or crowdsourced training feedback data which enables rapid data gathering. The crowdsourced training feedback data can include live, real-world data captured by a sensor (e.g., a camera) of a mobile terminal.

According to one aspect of the present disclosure, a method is provided including developing an artificial intelligence (AI) application including at least one model, the at least one model identifies a property of at least one input captured by at least one sensor; determining if the property of the at least one input is incorrectly identified; providing feedback training data in relation to the incorrectly identified property of at least one input to the at least one model; retraining the at least one model with the feedback training data; and generating an improved version of the at least one model.

In one aspect, the method further includes iteratively performing the determining, providing, retraining and generating until a performance value of the improved version of the at least one model is greater than a predetermined threshold.

In another aspect, the at least one input is at least one of an image, a sound and/or a video.

In a further aspect, the performance value is a classification accuracy value, logarithmic loss value, confusion matrix, area under curve value, F1 score, mean absolute error, mean squared error, mean average precision value, a recall value and/or, a specificity value.

In one aspect, the providing feedback training data includes capturing the feedback training data with the at least one sensor coupled to a mobile device.

In a further aspect, the at least one sensor includes at least one of a camera, a microphone, a temperature sensor, a humidity sensor, an accelerometer and/or a gas sensor.

In yet another aspect, the determining if the property of the at least one input is incorrectly identified includes determining a confidence score for an output of the at least one model and, if the determined confidence score is below a predetermined threshold, prompting a user to capture and label data related to the at least one input.

In one aspect, the determining if the property of the at least one input is incorrectly identified further includes presenting at least one of a saliency map, an attention map and/or an output of a Bayesian deep learning.

In a further aspect, the determining if the property of the at least one input is incorrectly identified includes analyzing an output of the at least one model, wherein the output of the at least one model includes at least one of a classification and/or a regression value.

In still a further aspect, the providing feedback training data includes enabling at least one first user to invite at least one second user to capture and label data related to the at least one input.

According to another aspect of the present disclosure, a system is provided including a machine learning system that develops an artificial intelligence (AI) application including at least one model, the at least one model identifies a property of at least one input captured by at least one sensor; and a feedback module that determines if the property of the at least one input is incorrectly identified and provides feedback training data in relation to the incorrectly identified property of at least one input to the at least one model; wherein the machine learning system retrains the at least one model with the feedback training data and generates an improved version of the at least one model.

In one aspect, the machine leaning system iteratively performs the retraining the at least one model and generating the improved version of the at least one model until a performance value of the improved version of the at least one model is greater than a predetermined threshold.

In another aspect, the at least one input is at least one of an image, a sound and/or a video.

In a further aspect, the performance value is a classification accuracy value, logarithmic loss value, confusion matrix, area under curve value, F1 score, mean absolute error, mean squared error, mean average precision value, a recall value and/or, a specificity value.

In yet another aspect, the feedback module is disposed in a mobile device and the at least one sensor coupled to the mobile device.

In one aspect, the at least one sensor includes at least one of a camera, a microphone, a temperature sensor, a humidity sensor, an accelerometer and/or a gas sensor.

In another aspect, the machine learning system determines a confidence score for an output of the at least one model and, if the determined confidence score is below a predetermined threshold, the feedback module prompts a user to capture and label data related to the at least one input.

In a further aspect, the feedback module is further configured present at least one of a saliency map, an attention map and/or an output of a Bayesian deep learning related to the at least one input.

In one aspect, the output of the at least one model includes at least one of a classification, a regression value and/or a bounding box for object detection and semantic segmentation.

In yet another aspect, the feedback module is further configured for enabling at least one first user to invite at least one second user to capture and label data related to the at least one input.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a flowchart illustrating overall processing steps carried out by a conventional machine learning training system;

FIG. 2 is a diagram illustrating components of the system of the present disclosure;

FIG. 3A is a diagram illustrating hardware and software components capable of being utilized to implement an embodiment of the system of the present disclosure;

FIG. 3B is a diagram illustrating hardware and software components capable of being utilized to implement an embodiment of the machine learning system of the present disclosure;

FIG. 3C is a diagram illustrating hardware and software components capable of being utilized to implement an embodiment of the mobile device of the present disclosure;

FIG. 4 is a flowchart illustrating overall processing steps carried out by the system of the present disclosure;

FIG. 5 is a diagram illustrating a machine learning task executed by the system of the present disclosure;

FIG. 6 is a screenshot illustrating the local software application in accordance with the present disclosure;

FIGS. 7-12 are screenshots illustrating operation of the software application of FIG. 6;

FIGS. 13A-14C are images illustrating operation of the software application of FIG. 6;

FIG. 15 is a table illustrating features and processing results of the system of the present disclosure;

FIGS. 16-17 are diagrams illustrating other tasks capable of being carried out by the system of the present disclosure; and

FIG. 18 is a diagram illustrating hardware and software components capable of being utilized to implement the system of the present disclosure.

It should be understood that the drawings are for purposes of illustrating the concepts of the disclosure and are not necessarily the only possible configuration for illustrating the disclosure.

### DETAILED DESCRIPTION

Preferred embodiments of the present disclosure will be described hereinbelow with reference to the accompanying drawings. In the following description, well-known functions or constructions are not described in detail to avoid obscuring the present disclosure in unnecessary detail. Herein, the phrase “coupled” is defined to mean directly connected to or indirectly connected with through one or more intermediate components. Such intermediate components may include both hardware and software based components.

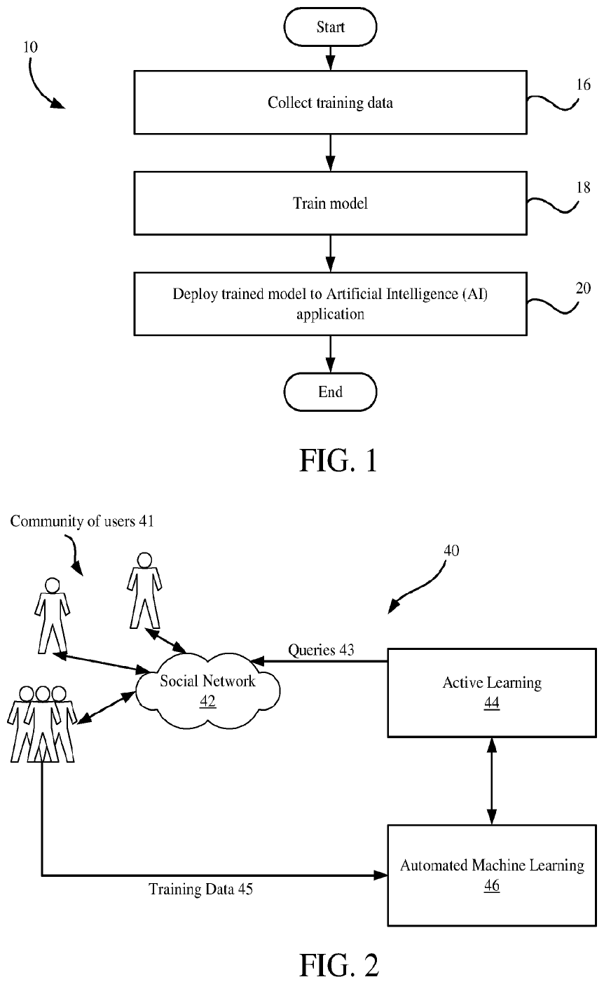

The present disclosure relates to systems and methods for improved training of machine learning systems, as discussed in detail below in connection with FIGS. 1-18.

The system of the present disclosure iteratively improves the training of a machine learning system by retraining a machine learning model thereof using crowdsourced training feedback data (e.g., labeled training data from a multitude of users) until the system converges on an iteration of the machine learning system that cannot be further improved or at least reaches an improvement of a predetermined threshold. The system provides several improvements over conventional systems and methods for training machine learning models. In particular, the system can include a local application for image classification executing on a mobile terminal (e.g., a smart phone or a tablet) which allows for lower latency since a conventional online application executing on a mobile terminal requires the transmission of an image to a server for inferencing and the receipt of the results by the mobile terminal. As such, the additional latency required by a conventional online application precludes the use of the crowdsourced training feedback data of the system. Further, a conventional online application requires the operation and maintenance of a plurality of servers which can be cost prohibitive. For example, the local application of the system of the present disclosure provides for image inferencing twice a second which is cost prohibitive if executed online and at scale. The local application of the system of the present disclosure also provides increased privacy because a local artificial intelligence (AI) application can perform image classification directly on the user's mobile terminal, i.e., because inferencing is happening on the local device avoiding the need to communicate over a network with other devices such as a server, privacy is maintained. Still further, another advantage of the local application of the present disclosure is that it can operate in areas that would be difficult or impossible for a conventional online system, such as underwater, in a cave, on an airplane, in a remote area, etc.

Additionally, conventional large online training datasets generally consist of similarly labeled data which provide less incremental value for increasing the performance of a machine learning system. In contrast, the crowdsourced training feedback data utilized by the system of the present disclosure can include live, real-world data captured by a sensor (e.g., a camera) of the mobile terminal. The training feedback data is smaller since a user is only capturing feedback data when the model inference is incorrect and/or undesired and as such, it is less computationally intensive and therefore less expensive to train the machine learning model.

Turning to the drawings, FIG. 1 is a flowchart 10 illustrating overall processing steps carried out by a conventional machine learning training system. In step 16, the system collects training data. In step 18, the system trains a machine learning model based on the collected training data and, in step 20, the system deploys a trained model to an artificial intelligence (AI) application.

FIG. 2 is a diagram 40 illustrating components of the system of the present disclosure. The primary components of the system are a social network 42, active learning 44 and automated machine learning 46. The social network 42 provides for building a community of users 41 around an AI application to develop the AI application via several means including, but not limited to, messaging, chat rooms, polls, video meetings, discussion threads, etc. Additionally, specific members of the community can invite other individuals to join the community and can assign new community members specific privileges in relation to developing the AI application. For example, a community administrator may invite a new community member and assign the new community member “contributor” privileges thereby allowing the new community member to contribute labeled data to train a machine learning model of the system. Additionally, non-community members may contribute labeled data without the need for invitation, where the labeled data provided by non-community members may or may not require approval by a community member.

Active learning 44 queries the community (as indicated by arrow 43) to label data with a desired output so that the community of users 41 provide the system with the training data 45, e.g., labeled data, to retrain the system machine learning model. It should be understood that active learning 44 can request or query a system user 41 to label data with a desired output and/or provide the system with labeled data to retrain the system machine learning model. Automated machine learning 46 provides for retraining of the system machine learning model and evaluating a performance of the system by comparing a performance of a most recent iteration of the system and a performance of the system based on the retrained machine learning model. In particular, the system can generate a new iteration of the trained model when the system exceeds a particular performance increase threshold. For example, if the retrained machine learning model improves system performance, e.g., mean average precision, by 5%, then the system can generate a new iteration of the machine learning model.

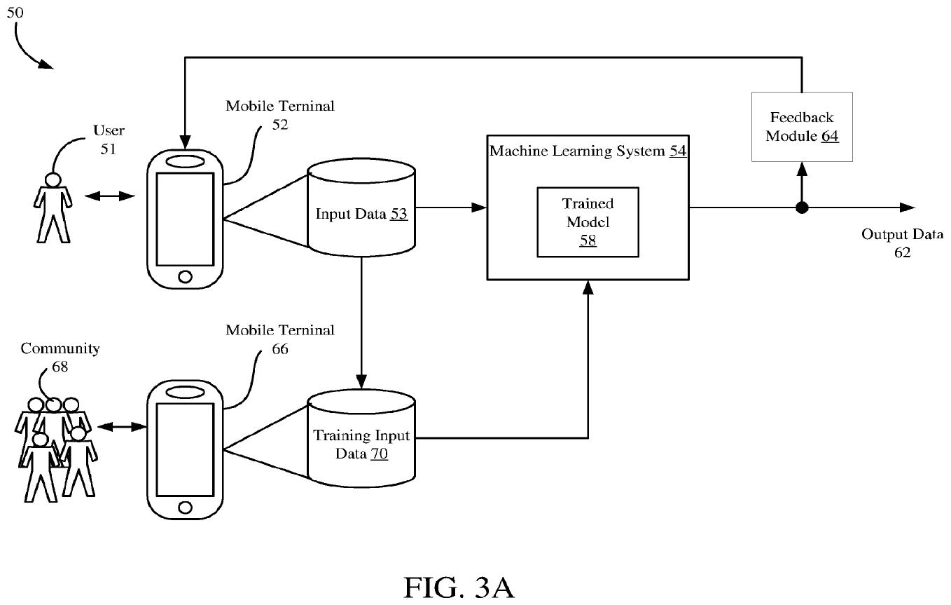

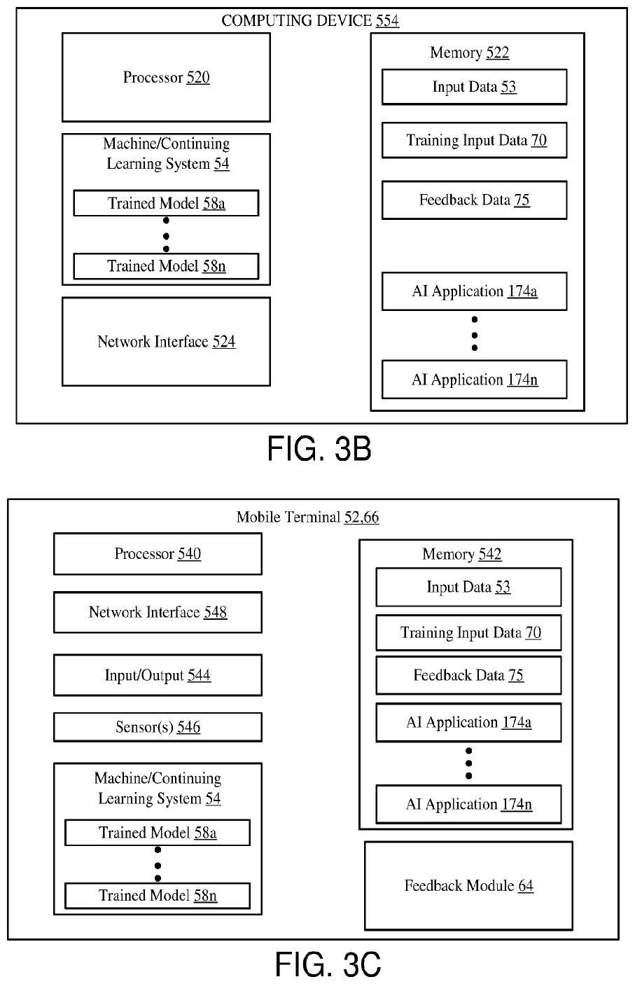

FIG. 3A is a diagram illustrating the system 50 of the present disclosure. The system 50 includes a machine learning system 54 having a trained model 58 which receives and processes input data 53 from a mobile terminal 52 of a user 51 and training input data 70 from mobile terminals 66 of users of the community 68. The input data 53 and the training input data 70 can each include labeled data. It is to be appreciated that the input data 53 includes labeled training data from user 51 and can also include unlabeled data that can be flagged to be labeled at a later time. The machine learning system 54 outputs output data 62. The machine learning system 54 can be any type of neural network or machine learning system, or combination thereof, modified in accordance with the present disclosure. For example, the machine learning system 54 can be a deep neural network and can use one or more frameworks (e.g., interfaces, libraries, tools, etc.). Additionally, the machine learning system 54 may employ linear regression, logistic regression, decision trees, Support Vector Machine (SVM), naive bayes classifier, random forests, gradient boosting algorithms, etc.

Additionally, the system 50 includes a feedback module 64 which processes the output data 62. Based on the processed output data 62, the feedback module 64 can notify the user 51 of the output data 62. The user 51 can label the output data 62 with a desired (e.g., correct) label and/or capture at least one image via the mobile terminal 52 to create feedback training data 75 which may be employed to improve the performance of the model 58. The user 51 can label the at least one image at the time of capture or label the image at a later time. It should be understood that a community 68 of the system 50 can also label the image at a later time. The training input data 70 is labeled by the community 68 via the mobile terminal 66. The labeled training input data 70 provides for retraining the trained model system 58. Validation input data is a subset of the training input data 70 that the user 51 or the community 68 provides. It should be understood that the training input data 70 and the validation input data originate from the same distribution but can be partitioned based on a partitioning algorithm.

It is to be appreciated that the system 50 of the present disclosure may be implemented in various configurations and still be within the scope of the present disclosure. For example, system 50 may be implemented as machine learning system 54 executing on a server 554 or other compatible device as shown in FIG. 3B and mobile terminal 52, 66 as shown in FIG. 3C. Referring to FIG. 3B, the server 554 may include at least one processor 520 for executing the machine learning system 54 where the machine learning system 54 accesses the trained model system 58. The server 554 may further include memory 522 that stores at least the input data 53 (e.g., input data received from mobile terminal 52 of user 51 to train at least one model), the training input data 70 (e.g., input data received from mobile terminal 66 of users of the community 66 to train at least one model), and the feedback data 75 (e.g., data received from user 51 and/or the community 66 to retrain at least one model after an initial model is generated). Memory 522 may include a plurality of AI applications 174a . . . n, as will be described below. The memory 522 may further include feedback data 75 that is provided by user 51 and the community 68 via their associated mobile terminals 52, 66. The server 554 further includes a network interface 524 that couples the server 554 to a network, such as the Internet, enabling two-way communications to mobile terminals 52, 66. The mobile terminals 52, 66 may upload feedback data 75 to the server 554 and/or download new or updated AI applications 174a . . . n and models 58a . . . n from the server 554.

Referring to FIG. 3C, mobile terminal 52, 66 may include at least one processor 540 for executing at least one AI application 174a . . . n residing on a memory 542 of the mobile terminal 52, 66. In one embodiment, the at least one processor 540 of the mobile terminal 52, 66 may execute the machine learning system 54 to retrain a model locally, fine tune a model locally and/or build an initial model from scratch. Memory 542 may further store at least the input data 53 and the training input data 70. The memory 542 may further include feedback data 75 that is provided by user 51 via their associated mobile terminal 52, 66. The mobile terminal 52,66 includes an input/output interface 544, e.g., a touchscreen display, that displays data to a user and receives input data from a user. Additionally, the mobile terminal 52, 66 includes at least one sensor 546 and/or sensor interface to capture data. In one embodiment, the at least one sensor 546 may include, but is not limited to, a camera, a microphone, a thermometer, an accelerometer, a humidity sensor and a gas sensor to capture and provide real world data. Alternatively, the at least one sensor 546 may include a sensor interface that couples a sensor externally from the mobile terminal 52, 66.

The mobile terminal 52, 66 further includes a network interface 548 that couples the mobile terminal 52, 66 to a network, such as the Internet, enabling two-way communications to server 554. The mobile terminals 52, 66 may upload feedback data 75 to the server 554 via the network interface 548. A feedback module 64 may prompt a user of the mobile terminal 52, 66 to provide feedback data, for example, when an AI application incorrectly identifies/classifies an object, as will be described in more detail below.

It is to be appreciated that the AI applications and models of the present disclosure may infer or predict various outputs based on inputs and is not to be limited to identifying and/or classifying an image. Consider a model of the present disclosure as:

f(x)=y

where f is the model, x is an input (e.g., an image, a video, a sound clip, etc.) and y is an output (e.g., cat, daytime, diseased liver, house price, etc.). When the output (i.e., y) is incorrect or undesired, the user and/or community may provide the correct feedback (i.e., correctly labeled data) based on the input to retain and/or fine tune the model.

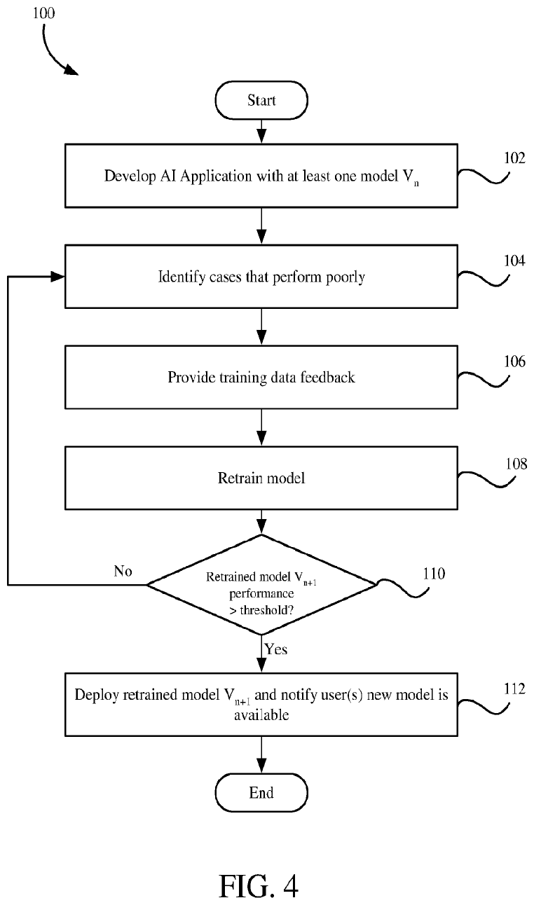

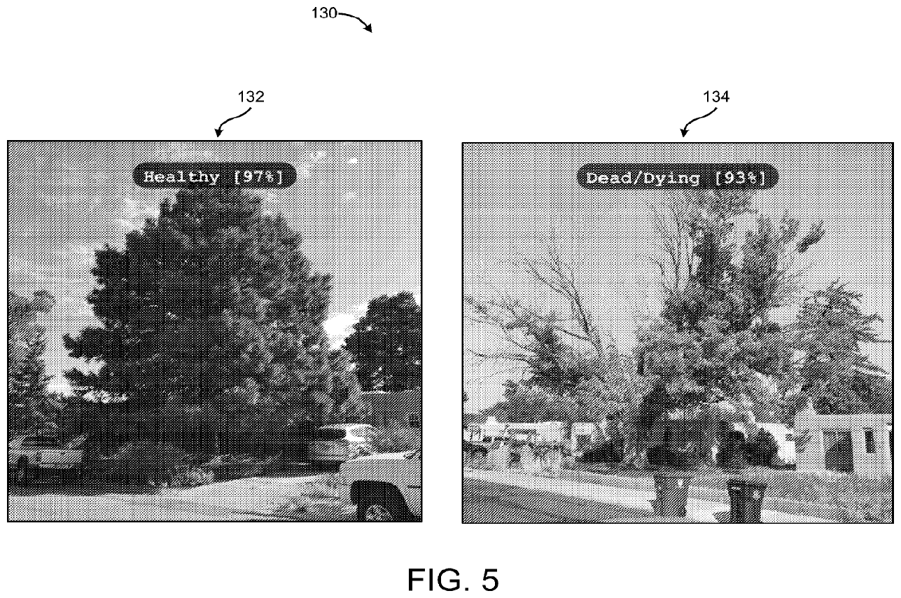

FIG. 4 is a flowchart 100 illustrating overall processing steps carried out by the system 50 of the present disclosure. Beginning in step 102, the system develops and implements an initial version of an AI application that includes at least one model (νₙ), which could include a neural network. As shown in FIGS. 5-14B, the AI application can be implemented to perform a variety of specific tasks including, but not limited to, identifying whether a tree is diseased and identifying a type of food. In other embodiments, an AI application may be configured for determining whether a scene or a dominant object present therein is wet, identifying objects commonly found in city streets, etc.

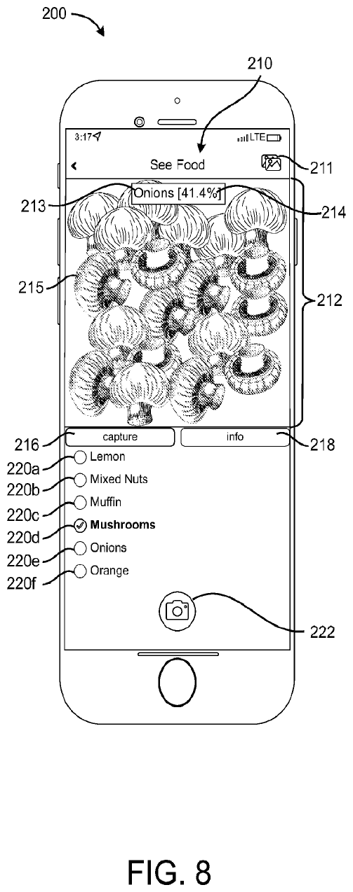

In step 104, the user 51 and/or the community 68 identifies cases that perform poorly, i.e., cases where a model incorrectly infers an output based on an input or the output is undesired. For example, the user 51 can determine whether a case performs poorly or can view cases that the community 68 has identified as performing poorly. As an example of a case performing poorly, assume a user 51 points the camera, e.g., sensor, of their mobile terminal 52 at a pile of mushrooms and the model infers and outputs that the input as sensed by the camera is onions, the details of this example will be further described below in relation to FIG. 8. As another example of a case performing poorly, the system may generate a confidence score associated with the output and, if the confidence score is below a predetermined threshold, the case will be deemed as performing poorly. As a further example, a thrashing output may be considered a poorly performing case. For example, a thrashing output is when the output may switch between different outputs in a rapid fashion, as opposed to the output would not be considered thrashing if the output stayed the same as the camera pans around. In yet another example, a case may be considered to be performing poorly or undesired if the output is correct but for the wrong reason, as will be described below.

Then, in step 106, the user 51 and/or community 68 provides the system 50 with training feedback data 75, e.g., data correctly labeled by a user or member of the community. It should be understood that the training feedback data 75 can be indicative of a desired (e.g., correct) label for a case that performs poorly and/or additional labeled data. In particular, the training feedback data 75 can be uploaded to the system 50 via a user interface of a mobile terminal 52, 66. The training feedback data 75 can be captured and stored on the mobile terminal and labeled at the moment the training feedback data 75 is captured or at a later time. Additionally, other members of the community 68 can re-label the training input data 70 after it is uploaded to the system 50. It should be understood that steps 104 and 106 are indicative of crowdsourced feedback (e.g., using the social network component 42 of the system 50) but the user 51 can also train the model 58 without the crowdsourced feedback to fine tune a model of an AI application 174a . . . n residing on the mobile terminal 52, 66. In one embodiment, when a user 51 captures feedback data, the feedback data may simultaneously be saved to the mobile terminal 52 to fine tune a locally stored model and be transmitted to the server 554 to retain a model stored on the server 554.

It is to be appreciated that there are three (3) scenarios where the user 51 may contribute labeled data without the community. First, user 51 may be the sole contributor that uploads training data to train a model on a server. Second, user 51 may capture data and label the captured data to train a model on the mobile terminal 52 from scratch. Lastly, user 51 may be the sole contributor that provides feedback data to fine tune an existing model regardless of whether the user created the existing model alone or created the existing model with a community.

In step 108, the system 50 retrains the model 58, e.g., a neural network, based on the training feedback data 75. In step 110, the system 50 determines whether a performance of the retained model Vₙ₊₁ is greater than a predetermined threshold, where the predetermined threshold may be determined by an AutoML function or may be user adjustable. The performance of the machine learning system 54 may be evaluated by metrics such as, but limited to, a classification accuracy value, logarithmic loss value, confusion matrix, area under curve value, F1 score, mean absolute error, mean squared error, mean average precision value, a recall value, and a specificity value. If the performance of the improved version of the model is not greater than the predetermined threshold, then the process iteratively returns to step 104 to collect more feedback data and retain the model until the performance of the improved version of the model Vₙ₊₁ is greater than the predetermined threshold. Alternatively, if the performance of the improved version of the model Vₙ₊₁ is greater than the predetermined threshold, in step 110, then the process ends. The improved version of the model is deployed and then stored in memory and an indication is transmitted to the mobile terminals 52, 66 to notify the users 51 and/or community 68 that an improved version of the model Vₙ₊₁ is now available for download, as will be described in more detail below.

In this way, the system 50 iteratively improves the model by retraining the model 58 with training feedback data 75 until the system 50 converges on an iteration of the model that cannot be further improved or at least reaches an improvement of a predetermined threshold. The system 50 realizes several improvements over conventional systems and methods for training machine learning models. In particular, conventional systems and methods for training machine learning models utilize one or more large training datasets acquired online. As such, each online training dataset is from a different distribution than the training input data 70 which is sourced by the community 68 via a user interface implemented by an application locally executed on the mobile terminal 66 and/or the user 51 via the user interface implemented by the application locally executed on the mobile terminal 52. By capturing the training input data 70 and/or training feedback data 75 via the mobile terminals 52, 66, the distributions for training the network 54 and inferencing are more similar. Additionally, large online training datasets generally contain similarly labeled data which provide less incremental value for improving the performance of a model. In contrast, the training feedback data 75 consists of live, real-world data captured by a sensor 546 (e.g., a camera) of the mobile terminals 52, 66 and is based on feedback from a multitude of users when it is determined that the model has an incorrect or undesired output for the input, e.g., has identified an object incorrectly. Accordingly, the training feedback data 75 is smaller and as such, it is less computationally intensive and therefore less expensive to train the network 54/model 58. Since the training feedback data 75 is based on feedback, members of the community 68 and/or the user 51 can more readily discover unique and challenging edge cases to include in the training feedback data 75 by probing the real world. It should be understood that the community 68 and/or the user 51 can utilize a variety of sensors including, but not limited to, a camera, a microphone, a thermometer, an accelerometer, a humidity sensor, and a gas sensor to capture and provide real world data.

FIG. 5 is diagram 130 illustrating a machine learning task executed by the system 50 of the present disclosure. As described above, the system 50 provides for implementing and training an AI to execute a specific task based on feedback. For example and as shown in FIG. 5, the system 50 can implement and train a model to execute the task of identifying and distinguishing between a healthy tree 132 and a diseased tree 134. In this example, a user 51 may point the camera, e.g., sensor, of their mobile terminal 52 at a tree and the output of the module as shown in images 132, 134 is displayed on a display of the mobile terminal 52.

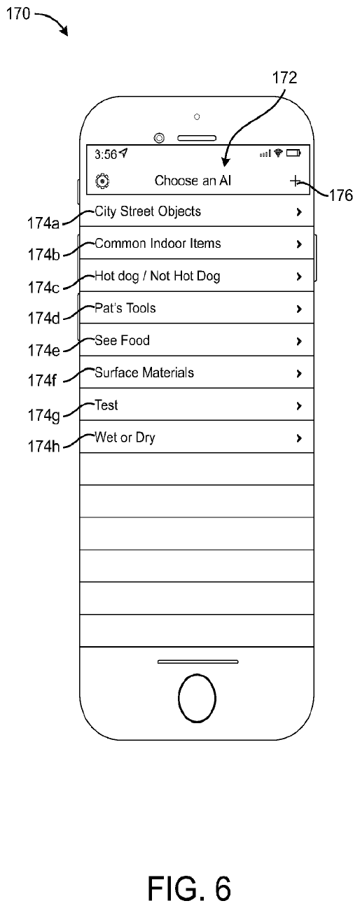

FIG. 6 is a screenshot 170 of showing a graphical user interface screen of the locally-executing software application of the system 50 of the present disclosure. In particular, FIG. 6 illustrates a graphical user interface screen displaying a selection menu 172 which allows a user to select from AI applications 174a-h for identifying and/or distinguishing between objects including City Street Objects 174a, Common Indoor Items 174b, Hot Dog/Not Hot Dog 174c, Pat's Tools 174d, See Food 174e, Surface Materials 174f, Test 174g, and Wet or Dry 174h. It should be understood that a user can also create and develop an AI application by utilizing the add button 176. It should also be understood that some AI applications may be less complex, i.e., requires less data and only general knowledge of the community member and/or user, than others where more complex AI applications (e.g., the AI application of FIG. 5) may require a community member and/or user expertise to re-label output data 62 and label training input data 70. For example, the AI application of FIG. 5 may require the community member and/or user to have expertise in identifying tree disease.

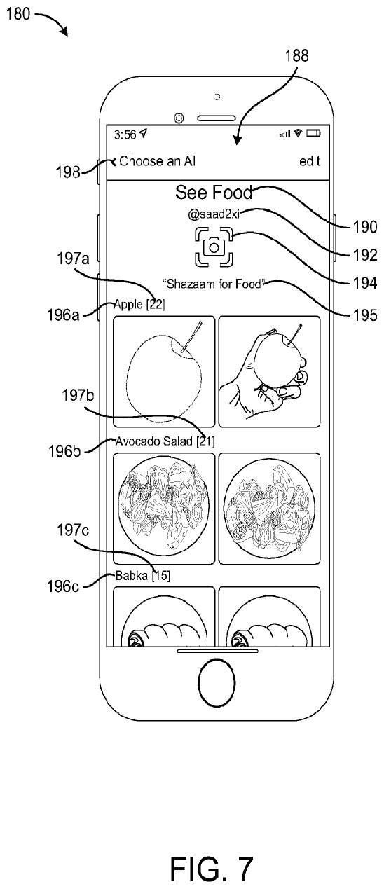

FIGS. 7-12 are screenshots illustrating tasks executed by the See Food AI application 174e of FIG. 6, where the See Food AI application 174e identifies food by receiving an image of food to be identified. In particular, FIGS. 7-12 are screenshots illustrating machine learning of different types of food by the See Food AI application 174e. FIG. 7 is a screenshot 180 of the graphical user interface displaying a homepage 188 of the See Food AI application 174e. As shown in FIG. 7, the homepage 188 includes a name 190 of the AI application (e.g., “See Food”), a username 192 (e.g., “@saad2xi”), a camera view icon 194, a description 195 indicative of the capabilities of the AI application and datasets 196a-c. The datasets 196a-c are indicative of an identified food and comprise a number of images 197a-c of the identified food. For example, dataset 196a is indicative of apples and comprises 22 images, dataset 196b is indicative of avocado salad and comprises 21 images, and dataset 196c is indicative of babka and comprises 15 images. It should be understood that a user can navigate back to the selection menu 172 via the back button 198 to select a different AI application.

FIG. 8 is another screenshot 200 of the See Food AI application 174e. In particular, FIG. 8 is a screenshot 200 of the graphical user interface displaying an identification page 210 of the See Food AI application 174e. A user can navigate to the identification page 210 from the homepage 188 via the camera view icon 194. As shown in FIG. 8, the See Food AI application 174e can identify an object 215 present in a camera view window 212 via a label 213 and with a confidence score 214. The confidence score 214 is a number that gives a user feedback on what the machine learning system 54 (e.g., a neural network) is inferring. In one non-limiting embodiment, the machine learning system 54 takes the raw output data 62 and passes the data 62 through a softmax function to determine the confidence score 214. The softmax function outputs a vector of numbers and the GUI displays the highest value in the that vector as the confidence score. For example, the See Food AI application 174e identifies the object 215 present in the camera view window 212 via a label 213 as being “onions” with a confidence score 214 of 41.4%. It should be understood that the See Food AI application 174e can identify a dominant object present in the camera view window 212 and as such, the camera view window need not be focused on a particular object present therein. If the user determines that the See Food AI application 174e does not correctly identify the object 215 present in the camera view window 212 based on the label 213 or that the confidence score 214 is too low or if the label 213 and/or confidence score 214 is inconclusive as the user pans the camera view window 212, then the user can select a classification label 220a-220f from the capture menu 216 that is potentially indicative of the object 215 present in the camera view window 212, where the selected classification label may be used as feedback data. For example, the user can select a classification label 220d indicative of “mushrooms” because mushrooms are present in the camera view window 212. Additionally, the user can capture an image of the object 215 and/or other images of the object 215 with the object label 220d by selecting the camera icon 222 and adding the captured images to a new or existing dataset. It should be understood that the system 50, can query the user to identify the object 215 present in the camera view window 212 when the object 215 is incorrectly identified via the label 213 or the confidence score 214 is less than a predetermined threshold. In one embodiment, user 51 decides whether the displayed image is incorrect and whether to capture an image to correct it. In another embodiment, if the model is outputting a low confidence score (i.e., below a predetermined threshold) or if the output is thrashing (i.e., jumping between different outputs, for example, first indicating onions, then indicating apples, then indicating peaches, etc.), the feedback module 64 may prompt the user 51 to provide feedback data, i.e., correctly label the image being displayed. A user can also select the information button 218 which provides information regarding the object 215 identified as being present in the camera view window 212 by the label 213.

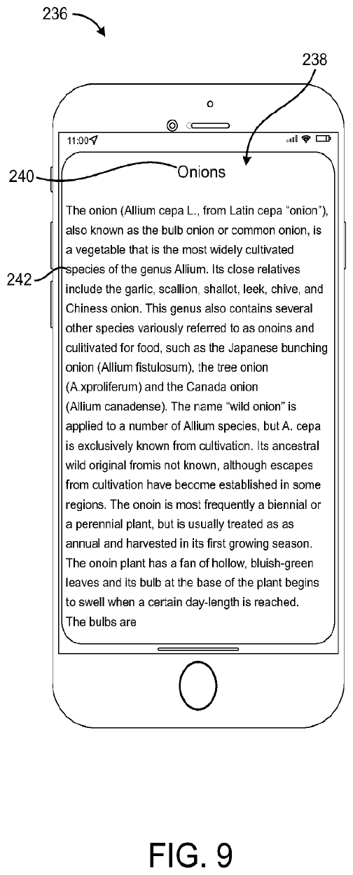

FIG. 9 is another screenshot 236 of the See Food AI application 174e. In particular, FIG. 9 illustrates the graphical user interface displaying an information page 238 of the See Food AI application 174e regarding the object 215 identified as being present in the camera view window 212 by the label 213 in FIG. 8. A user can navigate to the information page 238 from the identification page 210 by selecting the information button 218. As shown in FIG. 9, the information page 238 displays a name 240 of the object 215 and a description 242 of the object 215. It should be understood that in the present case the See Food AI application 174e mistakenly identifies the object 215 as being “onions” instead of mushrooms and as such, the name 240 of the object 215 and the description 242 thereof concern “onions.” The description 242 can include, but is not limited to, a biological classification (e.g., species and genus), a horticultural description for cultivating the object 215, a recipe utilizing the object 215, and a relevant advertisement (e.g., a coupon).

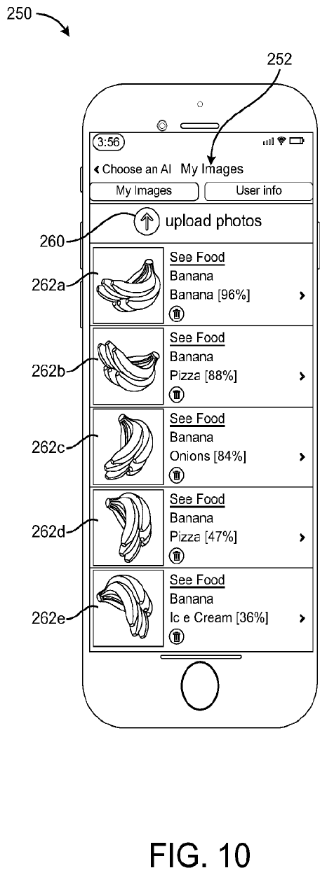

FIG. 10 is a screenshot 250 of an upload page showing the images a user 51 has on their mobile terminal 52. In particular, FIG. 10 illustrates a graphical user interface displaying an images page 252 including images 262a-e stored in a memory 542 of mobile terminal 52. A user can navigate to the images page 252 from the identification page 210 by selecting the images icon 211, as shown in FIG. 8. As shown in FIG. 10, the images page 252 comprises an upload photos icon 260 and labeled images 262a-e. A user can select one or more of the images 262a-e and upload the selected images to the system 50, e.g., server 554, by selecting the upload photos icon 260. The images 262a-e provide for retraining the model 58. The images 262a-e may also be employed locally on the mobile terminal 52 to fine tune (i.e., retrain locally or use continual learning) the trained model. Additionally, the images 262a-e may be employed to train a model locally on the mobile terminal 52 from scratch.

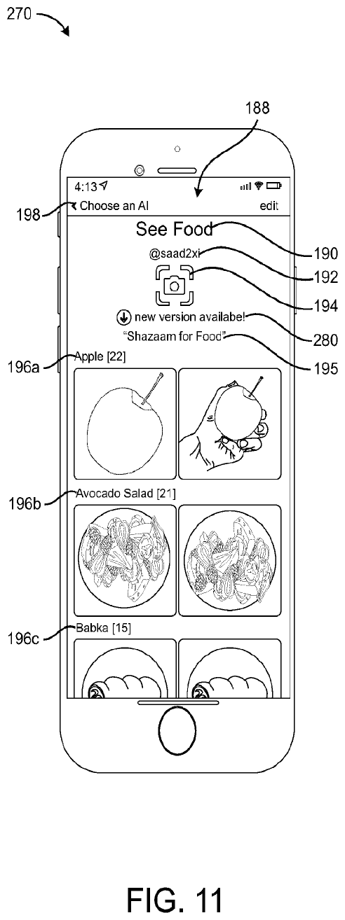

FIG. 11 is another screenshot 270 of the See Food AI application 174e. In particular, FIG. 11 illustrates the graphical user interface displaying an updated homepage 188. As shown in FIG. 11, the homepage 188 includes the name 190 of the AI application (e.g., “See Food”), the username 192 (e.g., “@saad2xi”), the camera view icon 194, the description 195 and the datasets 196a-c. Additionally, the homepage 188 includes a notification icon 280 which indicates that a new version (e.g., an improved version) of the See Food AI application 174e is available based on the retrained model 58. The user 51 may then download the improved version from server 554. As described above, if a performance of the system 50 based on the retrained network 54 realizes an improvement over a performance of the most recent iteration of the system 50 greater than a predetermined threshold, then the system 50 generates an improved version of the model. As shown in FIG. 11, the system 50 can notify a user that the newly improved version of the model is available.

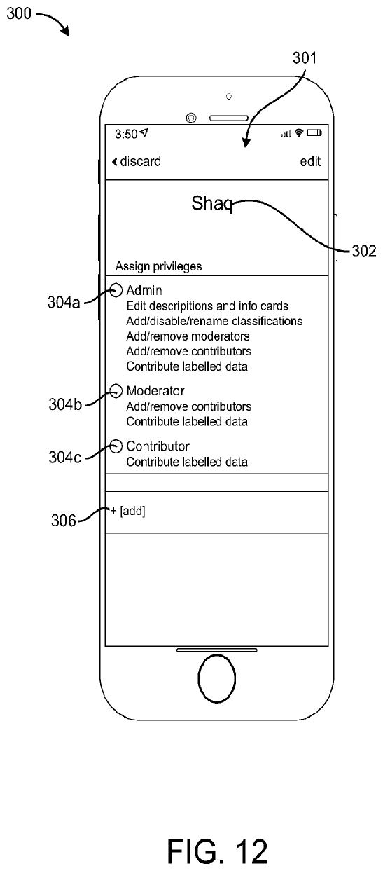

FIG. 12 is another screenshot 300 of the See Food AI application 174e. In particular, FIG. 12 illustrates the graphical user interface displaying an invitation page 301. As shown in FIG. 12, the invitation page 301 includes an invitee name 302, privilege classes 304a-c, and an add icon 306. As described above, the system 50 allows for specific members of the community to invite other individuals to join the community. In this case, the creator (e.g., user @saad2xi) of the See Food AI application 174e chooses an invitee named “Shaq” to join the See Food AI application 174e community. As a primary authority, the user @saad2xi can assign an invitee specific privileges in relation to developing the See Food AI application 174e via the privilege classes 304a-c. In particular, the “Admin” privilege class 304a allows an invitee to edit a description 242 and information of an information page 238, add, disable, or rename a classification, add or remove a moderator and a contributor, and contribute labeled data. Additionally, the “Moderator” privilege class 304b allows an invitee to add or remove a contributor and contribute labeled data and the “Contributor” privilege class 304c allows an invitee to contribute labeled data. Additional users can be added to the community via the add icon 306. It should be understood that the social network 42 allows community members to communicate to develop an AI application via several means including, but not limited to, instant messages, chat rooms, polls, video meetings, and discussion threads. It is to be appreciated community members may communicate with each other through the AI application, e.g., via an instant message and/or other means. Alternatively, community members may communicate through other social networking means such as Twitter™, Facebook™, etc. to invite a user to provide feedback data.

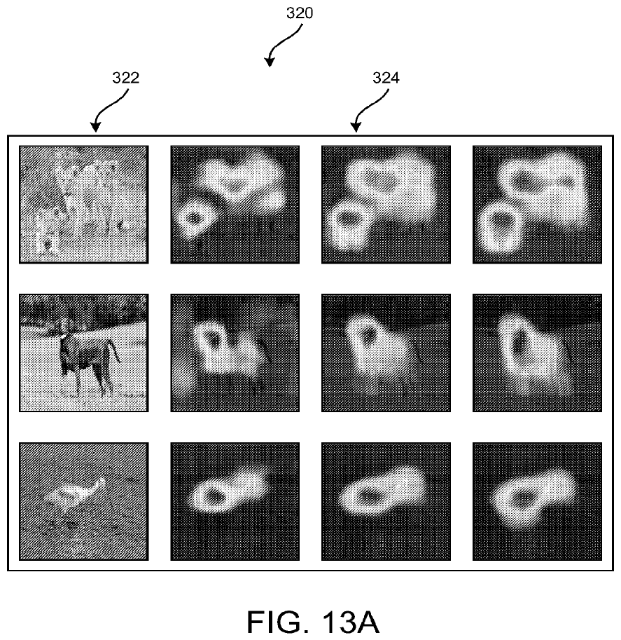

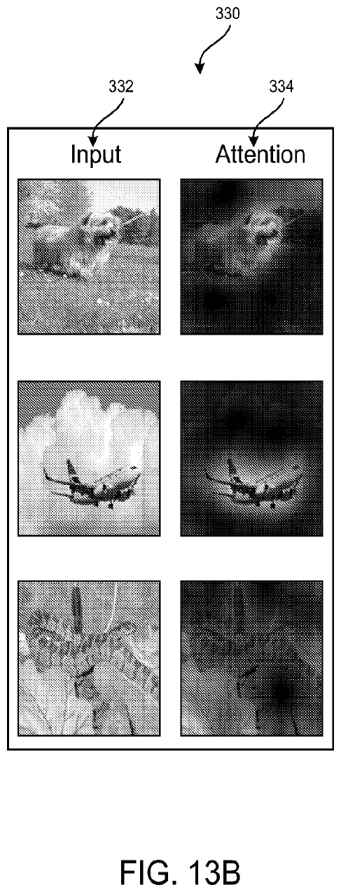

It is to be appreciated that the feedback module 64 may provide other data to a user 51 in addition or instead of the confidence score 214. In one embodiment, the feedback module 64 presents a saliency map 320 as shown in FIG. 13A. In FIG. 13A, the images 324 shown on the right is the saliency map of the image 322 on the left, where the saliency map shows the regions of the input image utilized by the machine learning system 54, such as a neural network, i.e., which pixels impacted the model's decision. In one embodiment, user 51 may select an icon (not shown) on the graphical user interface of FIG. 8 to have the saliency map displayed on the display of the mobile terminal. For example, user 51 may desire to look at the saliency map if the confidence score is below a predetermined threshold or if the user determined the label 213 for an image is incorrect. As a further example, in dermatology, a doctor may use an AI application to identify properties of a tumor, e.g., type, size, etc. The doctor may put a ruler next to a tumor to measure the tumor's size; however, if there is no tumor, there is no ruler. In one instance, the model may associate the presence of a ruler with a tumor diagnosis. By using a saliency map, the saliency map would show that the heatmap is highest around the ruler and not the tumor. Therefore, the saliency feedback would instruct the user to remove the ruler and then recapture image.

It is to be appreciated that even if the output of the model is correct, a user may desire to view the saliency map to see which pixels impacted the model's decision most. For example, in the tumor diagnosis example above, the model may be correct but for the wrong reason, i.e., the model may indicate there is a tumor due to presence of a ruler.

In another embodiment, the feedback module 64 presents an attention map 330 to the user 51, as shown in FIG. 13B. In FIG. 13B, the image 322 on the left is the input image and image 334 on the right illustrates the areas that the model uses when making an inference, i.e., the model is more attentive to the lighter portions of the image than the dark portions of the image. It is to be appreciated that a user may employ the attention map 330 in a similar manner to the saliency map 320, described above. For example, user 51 may desire to look at the attention map if the confidence score is below a predetermined threshold or if the user determined the label 213 for an image is incorrect. It is to be appreciated that even if the output of the model is correct, a user may desire to view the attention map to see which portion of the captured image impacted the model's decision most.

In a further embodiment, the feedback module 64 may present an output of a Baysian deep learning module to the user 51 as feedback. The output of a Baysian deep learning module may include an inference and an uncertainty value.

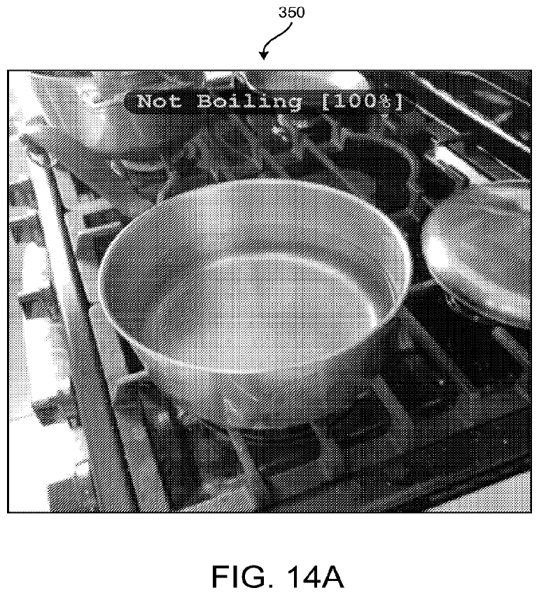

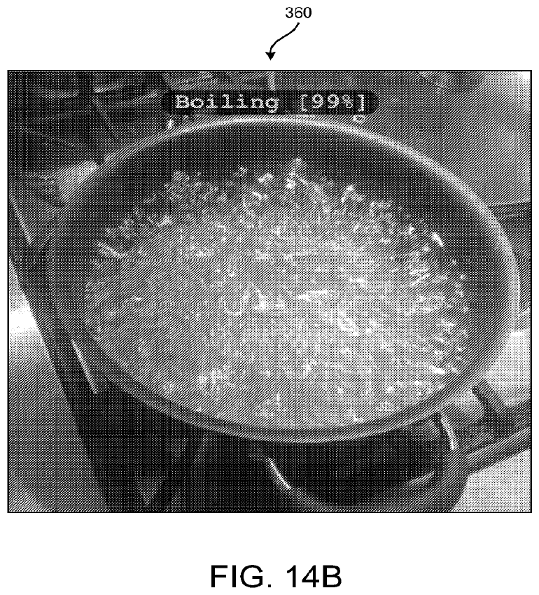

In one embodiment, the techniques of the present disclosure may further be utilized in automation applications. For example, the output of the AI application 174a . . . n may be utilized to trigger an event such as alerting a user, sending an email, etc. Referring to FIGS. 14A and 14B, an example of an automation application employing techniques of the present disclosure is illustrated. FIG. 14A illustrates an output 350 of an AI application showing a pot of not boiling water. In this example, a user 51 may situate the mobile terminal 52 (or other device) so the camera, e.g., sensor 546, of the mobile terminal 52 is directed at the pot of water. When the water starts boiling, the output 360 of the AI application will indicate that the water is boiling as shown in FIG. 14B. The AI application may be programmed to trigger an alert when the output of the AI application changes, i.e., changes from not boiling to boiling. The AI application can trigger the mobile terminal 52 (or other computing device) to sound alerts from the mobile terminal, trigger in-app alerts, send text messages, send email and integrate with 3^{rd} party technologies. As an example of 3^{rd} party technology integration, the AI application may send a message, via the network interface 548, to a home automation system to trigger an indication that the water is boiling such as flashing a light or lamp. The mobile terminal 52 or device can also send the output of the AI application and image to any http endpoint.

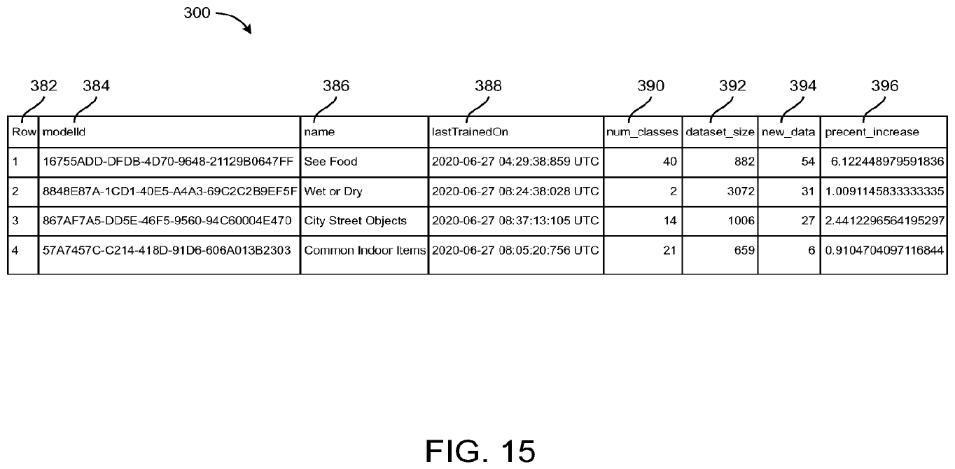

FIG. 15 is a table 380 illustrating features and processing results of the system 50 of the present disclosure. In particular, each row 382 of table 380 illustrates features and processing results of the aforementioned City Street Objects 174a, Common Indoor Items 174b, See Food 174e, and Wet or Dry AI 174h AI applications. As shown in table 380, the features include a model ID 384 of the model 58, a date 388 indicative of when the network 54 was last trained, a number of classes 390, a dataset size 392, and a number of new data 394 to retrain the model 58. In one embodiment, when the value of new data 394 exceeds a predetermined threshold, the machine learning system/network 54 retrains the model 58. The processing results include a percent increase 396 in the dataset size of the respective City Street Objects 174a, Common Indoor Items 174b, See Food 174e, and Wet or Dry 174h AI applications over previous versions thereof when the respective model 58 is retrained utilizing respective new data 394. It is to be appreciated that the model 58 is retrained utilizing the existing dataset plus the new data and not just the new data.

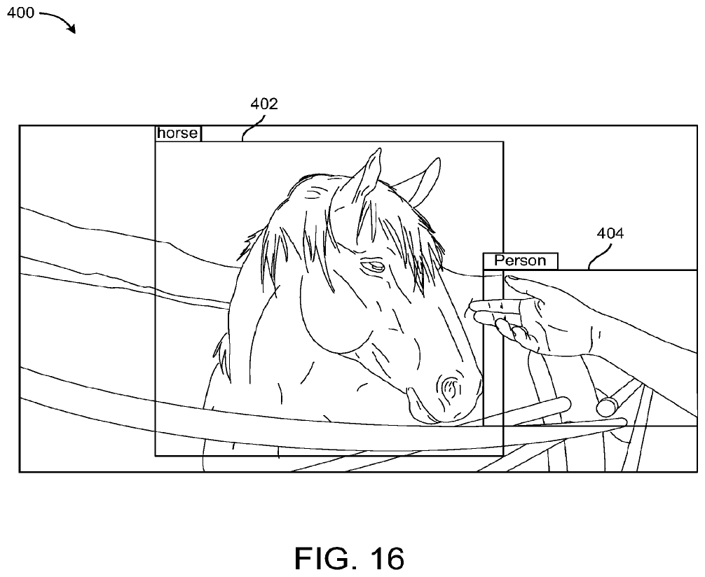

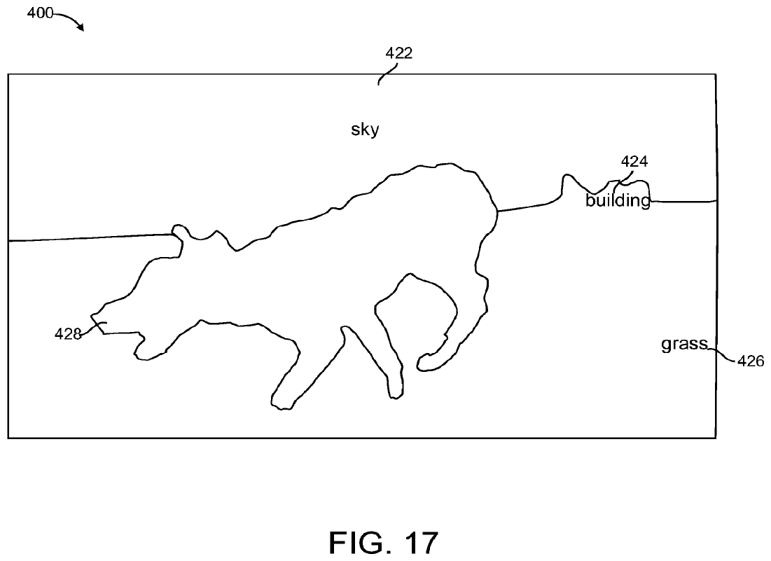

FIGS. 16-17 are diagrams 400 and 420 illustrating other tasks capable of being executed by other applications capable of being implemented by the system 50 of the present disclosure. It should be understood that the system 50 can be utilized to improve the training of a variety of machine learning systems. As shown in FIG. 16, the system 50 can be utilized to improve the detection and classification of multiple objects by locating multiple objects 402 and 404 present in an image via a bounding box and identifying and classifying the multiple objects 402 and 404 present in the image via user feedback. In one embodiment, user 51 may place a bounding box 402, 404 around an object and then label/identify the object to be used as training or feedback data. In another embodiment, the AI application may identify objects, place a bounding box around each identified object and then the user 51 labels/classifies each identified object.

Similarly and as shown in FIG. 17, the system 50 can be utilized to improve the delineation of multiple objects 422-428 (also known as semantic segmentation) present in an image via user feedback.

Additionally, the system 50 can be utilized to improve audio and video classification based on user feedback. As an audio classification example, say a user 51 wants to identify a dog's age based on the dog's bark. The model would listen to the bark (via a sensor 546 such as a microphone), predict an age of the dog and, if the output is wrong, the user 51 may capture the dog's bark again and correctly label the audio captured. As a video classification example, say a user 51 wants to identify plays of a basketball game. It is to be appreciated that it is not feasible for an image classifier to infer, for example, “passing a basketball” because no single image can definitively tell so. In this scenario, the system 50 needs a series of images (e.g., video) to perform this task. The model may process a series of images and may predict that a player is passing a ball, dribbling a ball, shooting a ball, etc. If a basketball player passes the ball but the model thinks the player is dribbling, the user 51 would be enabled to correct the classification of the video by relabeling the input images.

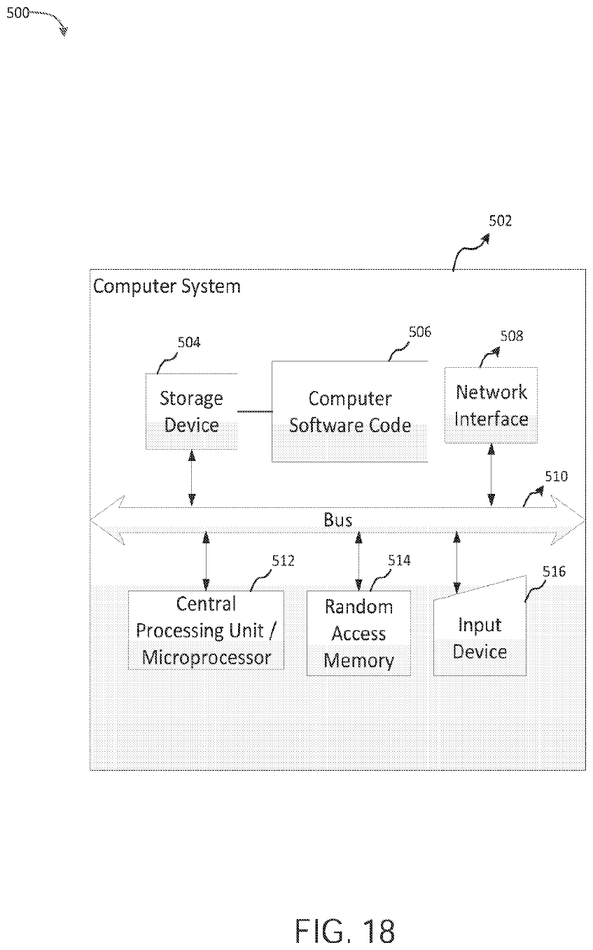

FIG. 18 is a diagram 500 showing hardware and software components of a computer system 502 on which an embodiment of the system of the present disclosure can be implemented. It is to be appreciated the components of system 52 may be embodied in the server 554 of FIG. 3B and/or mobile terminal 52,66 of FIG. 3C. It is further to be appreciated that the components of system may be embodied in other computing devices including, but not limited to, a personal computer (PC), a microcontroller (e.g., Arduino microcontroller) and a single board computer (e.g., Raspberry Pi and Nvidia Jetson single board computers). The computer system 502 can include a storage device 504, computer software code 506, a network interface 508, a communications bus 510, a central processing unit (CPU) (microprocessor) 512, a random access memory (RAM) 514, and one or more input devices 516, such as a keyboard, mouse, etc. The CPU 512 could be one or more graphics processing units (GPUs), if desired. The computing system 502 could also include a display (e.g., liquid crystal display (LCD), cathode ray tube (CRT), etc.). The storage device 504 could comprise any suitable, computer-readable storage medium such as disk, non-volatile memory (e.g., read-only memory (ROM), erasable programmable ROM (EPROM), electrically-erasable programmable ROM (EEPROM), flash memory, field-programmable gate array (FPGA), etc.). The computer system 502 could be a networked computer system, a personal computer, a server, a smart phone, tablet computer etc. It is noted that the computer system 502 need not be a networked server, and indeed, could be a stand-alone computer system.

The functionality provided by the present disclosure could be provided by computer software code 506, which could be embodied as computer-readable program code stored on the storage device 504 and executed by the CPU 412 using any suitable, high or low level computing language, such as Python, Java, C, C++, C#, .NET, MATLAB, etc. The network interface 508 could include an Ethernet network interface device, a wireless network interface device, or any other suitable device which permits the server 502 to communicate via the network. The CPU 512 could include any suitable single-core or multiple-core microprocessor of any suitable architecture that is capable of implementing and running the computer software code 506 (e.g., Intel processor). The random access memory 514 could include any suitable, high-speed, random access memory typical of most modern computers, such as dynamic RAM (DRAM), etc.

Furthermore, examples of the present disclosure may be practiced in an electrical circuit comprising discrete electronic elements, packaged or integrated electronic chips containing logic gates, a circuit utilizing a microprocessor, or on a single chip containing electronic elements or microprocessors. For example, examples of the present disclosure may be practiced via a system-on-a-chip (SOC) where each or many of the components illustrated in FIG. 18 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing device 502 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the present disclosure may be practiced within a general purpose computer or in any other circuits or systems.

It is to be appreciated that the various features shown and described are interchangeable, that is a feature shown in one embodiment may be incorporated into another embodiment. It is further to be appreciated that the methods, functions, algorithms, etc. described above may be implemented by any single device and/or combinations of devices forming a system, including but not limited to mobile terminals, servers, storage devices, processors, memories, FPGAs, DSPs, etc.

While the disclosure has been shown and described with reference to certain preferred embodiments thereof, it will be understood by those skilled in the art that various changes in form and detail may be made therein without departing from the spirit and scope of the disclosure as defined by the appended claims.

Furthermore, although the foregoing text sets forth a detailed description of numerous embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

What is claimed is:

1. A method comprising:
developing an artificial intelligence (AI) application including at least one model, the at least one model identifies a property of at least one input captured by at least one sensor;
determining if the property of the at least one input is incorrectly identified;
providing feedback training data in relation to the incorrectly identified property of at least one input to the at least one model;
retraining the at least one model with the feedback training data; and
generating an improved version of the at least one model.

2. The method of claim 1, further comprising iteratively performing the determining, providing, retraining and generating until a performance value of the improved version of the at least one model is greater than a predetermined threshold.

3. The method of claim 1, wherein the at least one input is at least one of an image, a sound and/or a video.

4. The method of claim 2, wherein the performance value is a classification accuracy value, logarithmic loss value, confusion matrix, area under curve value, F1 score, mean absolute error, mean squared error, mean average precision value, a recall value and/or, a specificity value.

5. The method of claim 1, wherein the providing feedback training data includes capturing the feedback training data with the at least one sensor coupled to a mobile device.

6. The method of claim 5, wherein the at least one sensor includes at least one of a camera, a microphone, a temperature sensor, a humidity sensor, an accelerometer and/or a gas sensor.

7. The method of claim 1, wherein the determining if the property of the at least one input is incorrectly identified includes determining a confidence score for an output of the at least one model and, if the determined confidence score is below a predetermined threshold, prompting a user to capture and label data related to the at least one input.

8. The method of claim 7, wherein the determining if the property of the at least one input is incorrectly identified further includes presenting at least one of a saliency map, an attention map and/or an output of a Bayesian deep learning.

9. The method of claim 1, wherein the determining if the property of the at least one input is incorrectly identified includes analyzing an output of the at least one model, wherein the output of the at least one model includes at least one of a classification and/or a regression value.

10. The method of claim 1, wherein the providing feedback training data includes enabling at least one first user to invite at least one second user to capture and label data related to the at least one input.

11. A system comprising:
a machine learning system that develops an artificial intelligence (AI) application including at least one model, the at least one model identifies a property of at least one input captured by at least one sensor; and
a feedback module that determines if the property of the at least one input is incorrectly identified and provides feedback training data in relation to the incorrectly identified property of at least one input to the at least one model;
wherein the machine learning system retrains the at least one model with the feedback training data and generates an improved version of the at least one model.

12. The system of claim 11, wherein the machine leaning system iteratively performs the retraining the at least one model and generating the improved version of the at least one model until a performance value of the improved version of the at least one model is greater than a predetermined threshold.

13. The system of claim 11, wherein the at least one input is at least one of an image, a sound and/or a video.

14. The system of claim 12, wherein the performance value is a classification accuracy value, logarithmic loss value, confusion matrix, area under curve value, F1 score, mean absolute error, mean squared error, mean average precision value, a recall value and/or, a specificity value.

15. The system of claim 11, wherein the feedback module is disposed in a mobile device and the at least one sensor coupled to the mobile device.

16. The system of claim 15, wherein the at least one sensor includes at least one of a camera, a microphone, a temperature sensor, a humidity sensor, an accelerometer and/or a gas sensor.

17. The system of claim 11, wherein the machine learning system determines a confidence score for an output of the at least one model and, if the determined confidence score is below a predetermined threshold, the feedback module prompts a user to capture and label data related to the at least one input.

18. The system of claim 17, wherein the feedback module is further configured present at least one of a saliency map, an attention map and/or an output of a Bayesian deep learning related to the at least one input.

19. The system of claim 11, wherein the output of the at least one model includes at least one of a classification, a regression value and/or a bounding box for object detection and semantic segmentation.

20. The system of claim 11, wherein the feedback module is further configured for enabling at least one first user to invite at least one second user to capture and label data related to the at least one input.
